(19) United States
(12) Patent Application Publication
(10) Pub. No.: US 2024/0199984 A1
(43) Pub. Date: Jun. 20, 2024

(54) METHODS AND COMPOSITIONS FOR RESTORING AND MAINTAINING HARD SURFACES

(71) Applicant: 3M INNOVATIVE PROPERTIES COMPANY, St. Paul, MN (US)

(72) Inventors: Donald T. Landin, Eagan, MN (US); Lijun Zu, Woodbury, MN (US); Feng Bai, Woodbury, MN (US); Benjamin R. Harkins, Anthony, MN (US)

(21) Appl. No.: 18/555,938

(22) PCT Filed: Apr. 1, 2022
(86) PCT No.: PCT/IB2022/053086

§ 371 Date: Oct. 18, 2023

Related U.S. Application Data
(60) Provisional application No. 63/201,238, filed on Apr. 20, 2021.

(51) Int. Cl. C11D 1/825; B24B 27/033; B24B 29/00; B24B 57/02; C11D 1/72; C11D 3/12; C11D 3/37; C11D 3/43

(52) U.S. Cl. CPC C11D 1/825; B24B 27/033; B24B 29/005; B24B 57/02; C11D 1/72; C11D 3/1246; C11D 3/373; C11D 3/3765; C11D 3/43; C11D 2111/24; C11D 2111/44

(57) ABSTRACT

Methods and related systems include applying a first fluid to a hard surface, grinding the hard surface using at least one structured-abrasive pad while removing the first fluid, applying a second fluid to the hard surface, and scrubbing the hard surface using a floor bristle brush while removing the second fluid. Some surface enhancement compositions include a first nonionic surfactant including alcohol alkoxylate, a second nonionic surfactant including a different alcohol alkoxylate, and a third nonionic surfactant having an amide functional group. Other compositions include a nonionic surfactant having alcohol alkoxylate, a polymer, and a siloxane.

The present technology generally relates to methods, compositions, and related systems for a concrete floor and, in particular, for restoring and maintaining a polished concrete floor.

Concrete is traditionally used for floors in both residential and commercial applications in view of its robustness and economic benefits. However, concrete typically has a relatively rough or porous surface. In general, it may desirable to enhance the surface appearance to provide a smoother appearance of concrete with a luster. Various attempts have been made to improve the aesthetic appearance of the concrete surface as used in building materials.

Also, like all flooring, concrete surfaces can be worn out due to traffic, leading to the dulling of the surfaces and loss of luster. Existing techniques involve labor intensive regular maintenance including periodic burnishing to restore the surface. Polished concrete floors are also cleaned routinely, for example, to remove stain, dirt, and dust. The cleaning is typically done involving the use of cleaning products.

### SUMMARY

The techniques of this disclosure generally relate to methods, compositions, and related systems for a concrete floor and, in particular, for restoring and maintaining a polished concrete floor. Methods of this disclosure, and related systems, provide a simplified solution for restoring and maintaining concrete floor surface with a luster appearance, which is also a dust free and slurry free process. Compositions of this disclosure provide a cleaning product to effectively clean the floor and simultaneously restore a worn surface.

In one aspect, the present disclosure provides a surface enhancement solution. The surface enhancement solution includes water, a first nonionic surfactant having alcohol alkoxylate, a second nonionic surfactant having alcohol alkoxylate different than the first nonionic surfactant, and a third nonionic surfactant having an amide functional group.

In another aspect, the present disclosure provides a surface enhancement solution including water, a nonionic surfactant having alcohol alkoxylate, a polymer, and a siloxane.

In yet another aspect, the present disclosure provides a method for restoring and maintaining a hard surface. The method includes applying a first fluid to the hard surface. The method also includes providing one, two, or three structured-abrasive pads each having a unique level of abrasive action. The method further includes grinding the hard surface using the one, two, or three structured-abrasive pads and concurrently removing the first fluid from the hard surface to restore the hard surface. Also, the method includes applying a second fluid to the hard surface. Further, the method includes scrubbing the hard surface using a floor bristle brush and concurrently removing the second fluid from the hard surface to maintain the hard surface. The floor bristle brush has bristles including moldable polymeric material and abrasive particle additives.

### BRIEF DESCRIPTION OF DRAWINGS

FIG. 1 is a conceptual diagram that illustrates components of a system for restoring and maintaining a hard surface.

FIG. 2 is a block diagram that illustrates a method for restoring and maintaining a hard surface usable in conjunction with the system of FIG. 1.

### DETAILED DESCRIPTION

The present disclosure provides methods and compositions for a concrete floor and, in particular, for restoring and maintaining a polished concrete floor. Methods of this disclosure, and related systems, provide a simplified solution for restoring and maintaining concrete floor surface with a luster appearance, which is also a dust free and slurry free process. Compositions of this disclosure provide a cleaning product to effectively clean the floor and simultaneously restore a worn surface.

Methods for restoring and maintaining may provide a dust-free and slurry-free concrete floor restoration and daily maintenance process. Such methods may allow for no down time to store aisles and main areas during the restoration process, as well as being dust free, while providing a lustrous smooth surface on the concrete. In some embodiments, techniques of the present disclosure provide a restoration and maintenance process that may facilitate: fewer abrasive pads, brushing passes, and overall steps to reach the same or better gloss or distinctness of image (DOI) compared to existing techniques and no slurry left on the floor during restoration.

Although the present disclosure describes methods in relation to concrete surfaces, such as concrete flooring, the method may be used with any suitable hard surface or flooring, such as marble, terrazzo, and granite. In general, hard surfaces are formed of inorganic materials. Hard surfaces may exclude organic-coated surfaces, such as acrylic- or polyurethane-coated floors.

In some embodiments, a method for restoring and maintaining a concrete floor surface may include grinding the concrete floor surface using one or more structured-abrasive pads, for example, by attaching them on a backer pad and then attaching the assembly onto the pad driver of a standard floor cleaning machine, such as an auto scrubber. The floor cleaning machine may be operated as it normally does for daily cleaning work during restoration. This restoration process can be repeated for several days or even weeks. Grinding during the restoration process can be done in a sequence using multiple structured-abrasive pads from lower grit to higher grit.

In some embodiments, a method for restoring and maintaining a concrete floor surface may include cleaning, or scrubbing, the concrete floor surface routinely with a floor bristle brush attached to a pad driver of a standard floor cleaning machine, such as an auto scrubber. The floor bristle brush may contain diamond. The cleaning solution can be water or a surface enhancement solution. Some surface enhancement solutions may include water, cleaner, densifier, or other components. Cleaning and polishing may maintain a gloss on a stone-based floor at or above an initial value using, for example, a low-speed auto scrubber with the floor bristle brush attached to the pad driver.

A system that may be used in conjunction with the method may include one or more structured-abrasive pads (e.g., 3M TRIZACT TZ Abrasive Pads, available from 3M Company, St. Paul, MN), a cleaning solution (e.g., water or a surface enhancement solution), a floor bristle brush (e.g., a brush having diamond-containing bristles), and optionally a floor cleaning machine (e.g., auto scrubber). The method may include providing one or more components of such a system. Such methods and systems for restoring and maintaining may provide a total solution for taking care of bare concrete floor in commercial buildings.

Compositions for restoring and maintaining a polished concrete floor may include a cleaning solution, such as a surface enhancement solution. In some embodiments, the surface enhancement solution may be used for both the restoring and maintaining processes. The surface enhancement solution may improve the appearance of polished concrete floors while cleaning the floor when used in conjunction with a floor bristle brush. Use of the surface enhancement solution in this manner may reduce the floor maintenance costs and labor, may provide long-lasting residual gloss enhancement and protection of the top layer of the floor, a reduction in the number of cleaning steps compared to existing techniques, and usable with autonomous or robotic scrubbing machines.

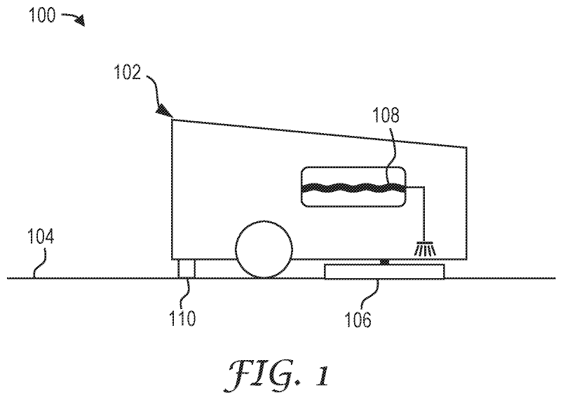

FIG. 1 shows components of a system 100 for restoring and maintaining a hard surface 104, such as a polished concrete floor. The system 100 may include a floor cleaning machine 102, such as an auto scrubber. The machine 102 may include a pad driver. A pad or brush 106 may be attached to the pad driver of the machine 102 and used to grind or scrub the surface 104. A cleaning solution 108, such as water or a surface enhancement solution, may be added to a tank of the machine 102. The cleaning solution 108 may be applied to the surface 104 during one or more steps of grinding or scrubbing and may interact with the pad or brush 106 attached to the pad driver of the machine 102. A suction element 110, or squeegee, may be included on the machine 102. The suction element 110 may be used to lift the cleaning solution 108, which may be in a slurry resulting from a grinding process, off the surface 104. The suction element 110 may be configured to be lifted up in an off position away from the surface 104 when removal of the cleaning solution 108 from the surface 104 is not desired, and the suction element 110 may be lowered down in an on position near the surface 104 to facilitate removal of the cleaning solution 108 from the surface 104 when desired.

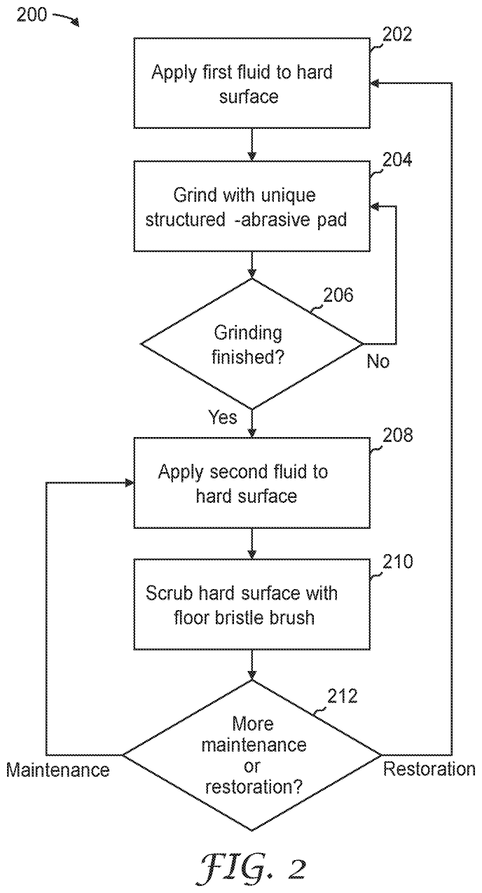

FIG. 2 is a block diagram that illustrates a method 200 for restoring and maintaining a hard surface, such as a hard floor surface, usable in conjunction with the system 100 of FIG. 1. In general, the method 200 may include a restoration portion (e.g., blocks 202, 204, 206) and a maintenance portion (e.g., blocks 208, 210).

Although not shown, the method 200 for restoring and maintaining may be preceded by a preparation process of the hard surface. The preparation process may be used when the hard surface has an unevenness or roughness above a desired threshold. The preparation process may bring the hard surface to an evenness or roughness suitable for restoration. In some embodiments, the preparation process includes grinding the floor with a slurry. In particular, the preparation process may include grinding the floor with an abrasive pad, such as a structured-abrasive pad, with a slurry and the suction element 110 (FIG. 1) lifted up for one or more passes. The suction element 110 may be lowered for the last pass to remove the slurry from the hard surface. More than one grinding step may be used each with a different abrasive pad.

The method 200 for restoring and maintaining the hard surface may include applying a first fluid to the hard surface in block 202. The first fluid may be a cleaning solution, such as water or a surface enhancement solution.

One or more pads may be provided for grinding. Each pad may be a structured-abrasive pad. Each pad may have a unique level of abrasive action, or grit level. In general, one, two, or three unique pads may be provided.

The method 200 may include grinding the hard surface with one of the pads in block 204. One or more passes of grinding may be performed using the pad.

In some embodiments, the first fluid may be applied continuously and concurrently while grinding. Also, the first fluid may be concurrently removed from the hard surface while grinding. In some embodiments, the suction element 110 (FIG. 1) may be lowered down for one, more, or all the passes while grinding. For example, the suction element 110 may be lowered for at least the last pass with the pad. In some embodiments, the suction element 110 may also be lifted up for one or more passes while grinding.

As used herein, the term “removed” in the context of a fluid means to substantially or completely remove the fluid from the hard surface.

If more grinding is needed in block 206, and the grinding is not finished, the method 200 may return to block 204 and include grinding with a new pad in block 204. The new pad has a unique abrasive action relative to the previously used pad. All the pads used in the method 200 may have a unique, or different, abrasive action. In some embodiments, up to two or three different pads and corresponding grinding steps may be used before the grinding is finished.

If the grinding is finished in block 206, the restoration portion of the method 200 may be deemed complete. The method 200 may proceed to the maintenance portion of the method 200.

The method 200 may include applying a second fluid to the hard surface in block 208. The second fluid may be a cleaning solution, such as water or a surface enhancement solution.

A floor bristle brush may be provided for scrubbing. The floor bristle brush may have bristles with moldable polymeric material and abrasive particle additives.

The method 200 may include scrubbing the hard surface with the floor bristle brush. One or more passes of scrubbing may be performed using the brush. Although any suitable number of passes may be used, in many, a hard surface may be scrubbed daily to provide a greater amount of time between restorations compared to existing techniques.

In some embodiments, the second fluid may be applied continuously and concurrently while scrubbing. Also, the second fluid may be concurrently removed from the hard surface while scrubbing. In some embodiments, the suction element 110 (FIG. 1) may be lowered down for one, more, or all the passes during scrubbing. For example, the suction element 110 may be lowered for at least the last pass with the pad. In some embodiments, the suction element 110 may also be lifted up for one or more passes during scrubbing.

In some embodiments, the first fluid and the second fluid are the same type of fluid, which may facilitate the ease of storing cleaning solutions. In other embodiments, the first fluid and the second fluid are different types, such as a surface enhancement solution and water, which may facilitate reducing the amount of surface enhancement solution needed.

In some embodiments, one or both of the first fluid and the second fluid, when applied, are free of abrasive particles harder than the hard surface, particularly when using structured-abrasive pads for grinding or floor bristle brushes having bristles with moldable polymeric material and abrasive particle additives. The hardness of the abrasive particle may be compared to the hardness of the hard surface using any suitable technique known to a person having ordinary skill in the art.

In general, the blocks of the method 200 may take place over the span of one or more days. The method 200 may also include determining whether more maintenance or restoration is desired in block 212. For example, after completing the maintenance portion (e.g., blocks 208, 210), the method 200 may include determining every day or every other day whether to repeat the maintenance portion (e.g., for daily cleaning or maintenance). The restoration portion of the method 200 (e.g., block 202, 204, 206) may be repeated in a less frequent cycle, such as every month (e.g., depending on traffic and wear).

The maintenance process and block 210 may be finished after a desired appearance, for example, in terms of gloss or DOI, is reached. In general, any suitable number of passes may be used, such as 1, 5, 10, 15, 20, 25, 30, 35, 40, or 44 passes over the course or a day, week, month, or more. Use of the method 200 may provide a hard surface having a minimum 60 degree average gloss and a minimum average DOI measured by a goniophotometer, such as the Rhopoint IQ (Goniophotometer) 20°/60°, available from IMBOTEC Group Company, Ontario, Canada. In some embodiments, the method 200 may provide an average DOI of at least 20, 25, 30, 35, or 40 after all grinding is finished (e.g., after restoration is finished). In some embodiments, the method 200 may provide a 60 degree average gloss of at least 5, 10, 15, 20, 25, 30, or 35 after scrubbing for 6, 12, 28, or 44 passes or after maintenance is finished. In some embodiments, the method 200 may provide an average DOI of at least 15, 20, 25, 30, 35, 40, or 45 after scrubbing to 6, 12, 28, or 44 passes or after maintenance is finished.

Any suitable pad may be used with the system 100 or the method 200. In some embodiments, one or more 3M TRIZACT TZ Abrasive Pads, available from 3M Company, St. Paul, MN, may be used. For example, the 3M TRIZACT TZ Abrasive Pad Gold, Red, and Blue may be used. Examples of suitable structured-abrasive pads suitable for use as a pad are described in International App. Pub. WO 2020/035764 (Smyth et al.), which is incorporated herein by reference.

In some embodiments, the structured-abrasive pads may include shaped—(including precisely shaped—) abrasive composites, which have a shape that results in at least one of a raised feature or recess on an exposed surface of an abrasive layer of the pad. Useful shapes may include square prisms, rectangular prisms, square pyramidal, rectangular pyramidal, truncated square pyramidal, and truncated rectangular pyramidal. Combinations of differently shaped and/or sized abrasive composites may also be used. The shaped abrasive composites may have planar and/or curved sides, for example. Preferably, the shaped-abrasive composites include at least one of square pyramids or rectangular pyramids. In some preferred embodiments, at least some of the shaped-abrasive composites, on a respective basis, the four sides meet at a single vertex. In some preferred embodiments, the shaped abrasive composites include (or even consist of) square pyramids.

Any suitable brush, or floor bristle brush, may be used with the system 100 or the method 200. In some embodiments, one or more diamond-containing floor brushes (or diamond floor brushes) may be used. Examples of suitable floor bristle brushes suitable for use as a pad are described in International App. Pub. WO 2019/175730 (Erickson et al.), which is incorporated herein by reference.

Various surface enhancement solutions may be used with the system 100 or the method 200. In general, a surface enhancement solution may be provided to facilitate cleaning and filling in pores in, or reducing pore density of, the hard surface. Some surface enhancement solutions may include multiple nonionic surfactants or functionalized siloxane. In one or more embodiments, the surface enhancement solutions may be provided in concentrated or ready-to-use (e.g., diluted) form. A ready-to-use solution may include at least 98 parts by weight of 100 parts by weight of the total solution.

Multiple nonionic surfactants may be provided to cooperatively facilitate either or both cleaning and surface enhancement functionalities. In some embodiments, the surface enhancement solution may include water and at least three nonionic surfactants.

In one or more embodiments, two of the nonionic surfactants may be different while both include an alcohol alkoxylate. For example, a first nonionic surfactant may include an alcohol alkoxylate and a second nonionic surfactant including alcohol alkoxylate different than the first nonionic surfactant. Suitable alcohol alkoxylates include alcohol ethoxylate, such as ECOSURF EH-6 surfactant available from Dow Chemical, Midland, MI and TOMADOL 900 surfactant available from Evonik Corporation, Allentown, PA.

In one or more embodiments, one of the nonionic surfactants may include an amide functional group. For example, a third nonionic surfactant may include an amide functional group. Suitable amide functional groups include unsaturated carbon chain with an amide functional group, such as STEPOSOL MET-10U available from Stepan Company, Northfield, IL, which may be described as N,N-dimethyl 9-decenamide. The amide-containing nonionic surfactant may have an oil-like consistency and may facilitate cleaning.

The amount of each nonionic surfactant may be selected based on the amount of another nonionic surfactant. In some embodiments, the amount of the first nonionic surfactant relative to the amount of the second nonionic surfactant may range between 1:9 to 9:1 ratio by weight. In some embodiments, the amount of the first nonionic surfactant relative to the amount of the third nonionic surfactant may range between 1:9 to 9:1 ratio by weight.

In one or more embodiments, a solubilizing agent may be included to facilitate solubility of one or more of the nonionic surfactants, such as those with an oil-like consistency that may not be water soluble or may be less than completely soluble. For example, a solubilizing agent may be included for the third nonionic surfactant having the amide that has aliphatic carbon chain, which may facilitate its solubility in water or other polar solvents. Suitable solubilizing agents include hydrotrope agents, such as monoethanolamine. The amount of the solubilizing agent may be selected based on the amount of corresponding one or more nonionic surfactants. For example, the amount of the third nonionic surfactant relative to the amount of the solubilizing agent may range between 1:2 to 2:1 ratio by weight.

In one or more embodiments, a siloxane may be included. Siloxane may be functionalized. Suitable siloxanes may include hydroxy-functional polydimethylsiloxane, which may be polyether-modified, such as SILCLEAN 3720 (25 wt. %) available from BYK USA Inc., Wallingford, CT. The functionalized siloxane may facilitate ease of cleaning and generate water repellency once applied to the hard surface.

In one or more embodiments, a glycol ether solvent may be included. Suitable glycol ether solvents may include ethyl carbitol solvent to facilitate cleaning.

In one or more embodiments, a polymer may be included, such as an acrylic polymer. Suitable acrylic polymers may include any type of polymer containing at least one type of acrylic monomer. The polymer can assume a wide variety of forms and can include one or more polymers (including, but not limited to polymers, copolymers, and terpolymers). In some embodiments, the polymer may be emulsion-based. In some embodiments, the polymer may be a self-crosslinking polymer. In some embodiments the polymer may be an acrylic polymer, acrylic copolymer, styrene-acrylic copolymers, or blends thereof. Acrylic homopolymers contain only one type of acrylate monomer, whereas the acrylic copolymers include two or more different types of acrylate monomers. Styrene-acrylic copolymers include at least one type of styrene monomer and one type of acrylate monomer. The acrylate monomers can include acrylic acid, butyl acrylate, ethyl acrylate, methyl acrylate, 2-ethyl hexyl acrylate, acrylonitrile, acrylamide, methacrylic acid, methyl methacrylate, ethyl methacrylate, butyl methacrylate, methacrylamide, and the like. Style monomers can include styrene, alpha-methyl styrene, and the like. Commercially available acrylic copolymers include methyl methacrylate/butyl acrylate/methacrylic acid (MMA/BA/MAA) copolymers, methyl methacrylate/butyl acrylate/acrylic acid (MMA/BA/AA) copolymers, and the like. One example of a suitable acrylic polymer emulsion is AVANSE 100 acrylic emulsion (50 wt. %). The use of polymer may be helpful to improve stain resistance.

In one or more embodiments, a silicate may be included. Suitable silicates may include lithium silicate, such as lithium polysilicate (20 wt. %). Silicate may facilitate filling in pores, which my result in higher gloss. Silicate may react with the hard surface material to facilitate further hardening of the surface.

In one or more embodiments, a siliconate may be included. For example, a siliconate may be included as an alternative to a silicate. Suitable siliconate may include potassium siliconate, such as XIAMETER OFS-0777 siliconate (20 wt. %) available from Dow Corning Co., Midland, MI. Silconate may be helpful to increase water repellency.

In one or more embodiments, nanosilica particles may be included. Suitable nanosilica particles may include an aqueous colloidal spherical silica dispersion, such as NALCO 2327 particles available from NALCO Chemical Company, Naperville, IL. Suitable nanosilica particles may also include modified nanosilica particles, such as anhydride silane modified nanosilica particles, for example, NALCO 2327 particles modified with a silica particle modifying agent, such as 3-(triethoxysilyl)propylsuccinic anhydride. Nanosilica particles may facilitate filling in pores, which my result in higher gloss. Nanosilica particles may react with the hard surface material to facilitate further hardening of the surface.

### EXAMPLES

A method of concrete floor cleaning and concrete floor surface enhancement compositions, or solutions, were formulated and tested using a slurry free restoration and cleaning/scrubbing process. The floor gloss and distinctness of image (DOI) impact of the composition and process were measured.

These examples are merely for illustrative purposes only and are not meant to be limiting on the scope of the appended claims. All parts, percentages, ratios, etc. in the examples and the rest of the specification are by weight, unless noted otherwise. The following abbreviations are used herein: nm=nanometer, cm=centimeter, in=inch, g=grams, oz=ounce, ° C.=centigrade, mL=milliliter.

### Materials

TABLE 1
Materials

| Abbreviation | | |
|---|---|---|
| (for Examples) | Description | Source |
| Ethyl Carbitol | Ethyl carbitol solvent | Available from Dow Chemical, |
| | | Midland, MI |
| Acrylic Emulsion | AVANSE 100 acrylic emulsion (50 wt. %) | Available from Dow Chemical, |
| | | Midland, MI |
| Monoethanolamine | Monoethanolamine | Available from Dow Chemical, |
| | | Midland, MI |
| EH-6 | ECOSURF EH-6 surfactant | Available from Dow Chemical, |
| | | Midland, MI |
| TM 900 | TOMADOL 900 surfactant | Available from Evonik |
| | | Corporation, Allentown, PA |
| Li Silicate | Lithium polysilicate (20 wt. %) | Available from W. R. Grace, |
| | | Columbia, MD |
| SILCLEAN | SILCLEAN 3720 (25 wt. %) | Available from BYK USA Inc., |
| | | Wallingford, CT |
| Potassium | XIAMETER OFS-0777 siliconate (20 | Available from Dow Corning Co., |
| Siliconate | wt. %) | Midland, MI |
| Silica Particles | 40% aqueous colloidal spherical silica | Available from NALCO Chemical |
| | dispersion - 20 nm silica NALCO 2327 | Company, Naperville, IL |
| | (stabilized with ammonium ion, Mean | |
| | Particle Diameter = 20 nm) | |
| Silica Particle | 3-(triethoxysilyl)propylsuccinic anhydride | Available from Gelest, |
| Modifying Agent | | Morrisville, PA |
| MET 10U | STEPOSOL MET-10U | Available from Stepan Company, |
| | | Northfield, IL |
| LUSTER | LUSTER Stone Care Restorative Cleaner | Available from Spartan, Maumee, |
| | | OH |
| PENTRA-CLEAN | PENTRA-CLEAN (CR) Cleaner Restorer | Available from Convergent |
| | | Concrete Technology, Orem, UT |
| PEBAX 6333 | PEBAX 6333 SA-01, Polyamide-based | Available from Arkema Inc., King |
| | thermoplastic elastomer | of Prussia, PA |
| MB 50-010 | Siloxane polymer lubricant | Available from Dow Corning, |
| | | Midland, MI |
| GC 3000 | Abrasive - green silicon carbide | Available from Fujimi |
| | | Corporation, Tualatin, OR |
| Diamond | 3 Micrometer Diamond Agglomerates | Made according to the method |
| Agglomerates | | disclosed in PCT App. No. |
| | | 2019/138324 Al (Lijun et al.) |
| | | (page 9, lines 1-23) |

### 3M TRIZACT TZ Abrasive Pads

During testing of the Examples, 3M TRIZACT Diamond TZ Abrasive Pads Gold, Red, and Blue available from 3M Company, St. Paul, MN were used.

### Foam Backer Pad for 3M TRIZACT TZ Abrasive Pads

To provide the foam backer pad, HYPUR-CEL R1205 foam with ½ in. thickness was purchased from Rubberlite, Huntington, WV. The foam was laminated with a knit fabric 1733 (purchased from Gehring-Tricot Corp., St. Johnsville, NY) on both sides of the foam, and then cut into a 20 in. circle.

### Floor Bristle Brush for Maintenance/Scrubbing

To provide the floor bristle brush, a molded abrasive bristle brush was fabricated by injection molding according to the method disclosed in U.S. Pat. No. 5,679,067 (Johnson et al.) using the formulation for an injection molded bristle brush shown in Table 2 of the present disclosure. The mold design used is shown in U.S. Pat. No. 5,679,067 (Johnson et al.) at FIG. 11. The base was a generally wedge-shaped polygon, 10.5 cm (4.125 in) long by 3.8 cm (1.5 in) wide at one end and 2.2 cm (0.875 in) wide at the opposite end. Extending from one major surface were 440 bristles each 1.5 cm (0.59 in) long, 2.3 mm (0.090 in) diameter at the root and 1.0 mm (0.040 in) diameter at tip. The 9.5 mm (0.375 in) long portion of the bristle adjacent tip was cylindrical. The back of the base was flat. 16 of the wedge-shaped bristle brushes were mounted on a 20 in. foam plate at an equal interval towards the outer circle.

TABLE 2
Formulation for Injection Molded Bristle Brush

| Materials | Wt. % |
|---|---|
| PEBAX 6333 | 56.4 |
| MB 50-011 | 11.28 |
| GC 3000 | 7.32 |
| Diamond Agglomerates | 25 |

### Test Methods

Each Example was tested on a bare concrete floor using Tennant T3 Auto Scrubber (20 in. single head) available from Tennant Co., Minneapolis, MN. Gloss and DOI values of the concrete floor surface were measured using a Rhopoint IQ (Goniophotometer) 20°/60°, available from IMBOTEC Group Company, Ontario, Canada. Within a testing area of about one foot by one foot, an average of 5 measurements were recorded for both 60 degree gloss and DOI readings.

### Examples E1-E5 and CE1-CE2

Formulations for Examples E1-E5 are listed in Table 3.

TABLE 3
Compositions of E1-E5 (by 100 parts by total weight)

| Raw Materials | E1 | E2 | E3 | E4 | E5 |
|---|---|---|---|---|---|
| DI H2O | 47.96 | 63.50 | 74.87 | 49.28 | 60.66 |
| EH-6 | 4.80 | 1.58 | 1.58 | 1.58 | 1.58 |
| TM900 | | 1.58 | 1.58 | 1.58 | 1.58 |
| Monoethanolamine | | 1.58 | 1.58 | 1.58 | 1.58 |
| MET 10U | | 1.42 | 1.42 | 1.42 | 1.42 |
| Ethyl Carbitol | 3.60 | 7.58 | 7.58 | 7.58 | 7.58 |
| Li Silicate | 23.98 | 22.75 | | 22.75 | |
| SILCLEAN | 1.68 | | | | |
| Potassium Siliconate | 3.60 | | | | |
| Modified Silica | | | 22.75 | | 11.37 |
| Particles | | | | | |
| Acrylic Emulsion | 14.39 | | | 14.22 | 14.22 |

Example 1 (E1) was prepared as follows: To a 200 mL glass beaker containing a magnetic stir bar were added 47.96 g of deionized (DI) water, 3.60 g of Ethyl Carbitol while stirring, 1.68 g of SILCLEAN was added. After the mixture was stirred for 30 minutes, 4.80 g of EH-6 was then added to the beaker followed by the addition of 14.39 g of Acrylic Emulsion. After 30 minutes stirring of this mixture, 23.98 g of Li Silicate was added followed by the addition of 3.60 g of Potassium Siliconate. The beaker was covered with alumina foil and the final mixture was stirred for overnight to be ready for use.

Modified Silica Particles were prepared as follows: 1000 grams of Silica Particles were added to a glass jar equipped with a magnetic stir bar. While stirring at room temperature, 15 grams of Silica Particle Modifying Agent was slowly added to the Silica Particles containing glass jar through a dropper over a period of 10 minutes while stirring well. After the addition was complete, the mixer was stirred for another 30 minutes, and the jar was sealed and placed in a 90° C. oven for 20 hours (no stirring while in oven). Upon cooling to room temperature, anhydride silane modified silica parties, or Modified Silica Particles, having 41.5% solids were obtained.

Example 2 (E2) was prepared as follows: To a 100 mL glass beaker containing a magnetic stir bar were added 35.50 g of DI water, 4.00 g of Ethyl Carbitol, while stirring, 0.84 g of Monoethanolamine, 0.75 g of MET 10U, followed by the addition of 0.84 g of EH-6 and 0.84 g of TM 900. After 30 minutes stirring of this mixture, 12.00 g of Li Silicate was added, then after another 30 minutes stirring, the sample was ready for use.

Examples 3-5 (E3-E5) were prepared in a similar procedure as described for E2 using the formulations in Table 3.

Comparative Example 1 (CE1) was commercially available PENTRA-CLEAN diluted based on manufacturer recommended dilution ratios.

Comparative Example 2 (CE2) was commercially available LUSTRE diluted based on manufacturer recommended dilution ratios.

### Concrete Floor Restoration (Grinding) and Maintenance (Cleaning Scrubbing)

The concrete floor was prepared using first 3M TRIZACT Diamond TZ Gold Abrasive Pads then 3M TRIZACT Diamond TZ Red Abrasive Pads following the procedure below. Tennant T3 Auto Scrubber was used with the abrasive pads.
1. Prepare new 3M TRIZACT Diamond TZ Abrasive Pad Gold, Red, and Blue for use by making preliminary passes to expose the abrasive using the Tennant T3 Auto Scrubber with water on. The pads were conditioned for use when slurry appeared on the floor.
2. Make 6 passes with the 3M TRIZACT Diamond TZ Abrasive Pad Gold on the Tennant T3 Auto Scrubber with its squeegee up and water on. The last pass was performed with the squeegee down.
3. Auto scrub with a 3M Red Buffer Pad 5100 available from 3M Company on the Tennant T3 Auto Scrubber was performed.
4. Make 6 passes with the 3M TRIZACT Diamond TZ Abrasive Pad Red on the Tennant T3 Auto Scrubber with squeegee up and water on. The last pass was performed with the squeegee down.
5. Auto scrub with a 3M Red Buffer Pad 5100 on the Tennant T3 Auto Scrubber.

After preparation, the concrete floor had a pre-dulling surface with an average gloss reading of 3 and an average DOI reading of 0.

The concrete floor was restored as follows: A 3M TRIZACT Diamond TZ Abrasive Pad Blue was attached to the foam backer pad in the 12:00, 3:00, 6:00, and 9:00 o'clock positions. The whole assembly was attached to the pad driver of T3 Auto Scrubber. The T3 Auto Scrubber was operated as it normally does for daily cleaning work. The same area was scrubbed for 6 passes with squeegee down and water on. After this restoration process, the average 60 degree gloss and DOI readings were measured using Rhopoint IQ 20 /60° meter and are listed in Table 4.

### Testing of E1

E1 was tested on a concrete floor in a first location. After the floor restoration process described above using 3M TRIZACT Diamond TZ Blue Abrasive Pad, the average 60 degree gloss reading was in the range of 8-10, and the average DOI reading was in the range of 9-14.

The water tank of T3 Auto Scrubber was well cleaned with water. 59.1 mL (2 ounces) of E1 was diluted with 4 gallons of water in a 5-gallon buckets, and then added to the T3 Auto Scrubber tank.

The floor bristle brush was attached to the pad driver of T3 Auto Scrubber. The T3 Auto Scrubber was operated as it normally does for daily cleaning work. The same restored area was scrubbed for 28 passes using the T3 Auto Scrubber with the squeegee down and water on. The average 60 degree gloss and DOI were measured after 6 passes, 12 passes, and 28 passes, respectively. Testing was conducted with water and with E1 separately. Data is listed in Table 4.

TABLE 4
Average 60 Degree Gloss and DOI Readings on a Concrete Floor

| | Floor Bristle | | Floor Bristle | |
|---|---|---|---|---|
| | Brush Scrubbing | | Brush Scrubbing | |
| | with water | | with E1 | |
| | Gloss | DOI | Gloss | DOI |
| After Restoration | 8.4 | 9.2 | 9.6 | 13.3 |
| After 6 passes of scrubbing | 13 | 19.7 | 15.7 | 29 |
| After 12 passes of scrubbing | 17.3 | 25.8 | 25.2 | 37.4 |
| After 28 passes of scrubbing | 24.4 | 29.1 | 35.7 | 48.2 |

### Testing of Example 2 (E2)

E2 was tested on a concrete floor in a second location. After floor restoration process described above using the 3M TRIZACT Diamond TZ Blue Abrasive Pad, the average 60 degree gloss reading was in the range of 5-8, and the average DOI reading was in the range of 30-45.

The water tank of the T3 Auto Scrubber was well cleaned with water. 63.3 mL (2.1 ounces) of E2 was diluted with 3 gallons of water in a 5-gallon bucket, and then added to the T3 Auto Scrubber tank.

The floor bristle brush was attached to the pad driver of T3 Auto Scrubber. The T3 Auto Scrubber was operated as it normally does for daily cleaning work. The restored area in the second location was scrubbed for 44 passes using the T3 Auto Scrubber with the squeegee down and water on. The average 60 degree gloss and DOI were measured after 6 passes, 12 passes, 28 passes and 44 passes, respectively. Data is listed in Table 5.

### Testing of E3-E5 and CE1-CE2

Testing of E3-E5 and CE1-CE2 were conducted in the same way as described for E2, except the dilution ratios below were used.
E3: 63.3 mL (2.11 OZ) used with 3 gallons of water.
E4: 36.0 mL (1.2 OZ) used with 3 gallons of water.
E5: 36.0 mL (1.2 OZ) used with 3 gallons of water.
CE1: 30 mL (1 OZ) used with 3.75 gallons of water.
CE2: 180 mL (6 OZ) used with 3 gallons of water.

TABLE 5
Average 60 Degree Gloss and DOI Readings on a Concrete Floor

| | Diamond | | Diamond | | Diamond | | Diamond | | Diamond | | Diamond | |
|---|---|---|---|---|---|---|---|---|---|---|---|---|
| | Floor Brush | | Floor Brush | | Floor Brush | | Floor Brush | | Floor Brush | | Floor Brush | |
| | Scrubbing | | Scrubbing | | Scrubbing | | Scrubbing | | Scrubbing | | Scrubbing | |
| | with E2 | | with E3 | | with E4 | | with E5 | | with CE1 | | with CE2 | |
| | Gloss | DOI | Gloss | DOI | Gloss | DOI | Gloss | DOI | Gloss | DOI | Gloss | DOI |
| After | 7.9 | 37.1 | 7.7 | 34.9 | 9.5 | 42.9 | 5.7 | 28 | 7.7 | 36.9 | 7.2 | 30.8 |
| Restoration | | | | | | | | | | | | |
| After 6 | 13.1 | 30.1 | 10 | 17 | 11.4 | 24 | 7.3 | 26.7 | 8.7 | 23 | 9.1 | 27.1 |
| passes of | | | | | | | | | | | | |
| scrubbing | | | | | | | | | | | | |
| After 12 | 22.8 | 27.7 | 16 | 34.2 | 22.8 | 39.7 | 11.5 | 30.3 | 12.7 | 36.7 | 12.8 | 26.8 |
| passes of | | | | | | | | | | | | |
| scrubbing | | | | | | | | | | | | |
| After 28 | 28.3 | 42.8 | 19.6 | 27.3 | 28.3 | 38.5 | 16.1 | 26.7 | 15.3 | 29.9 | 18.5 | 28.5 |
| passes of | | | | | | | | | | | | |
| scrubbing | | | | | | | | | | | | |
| After 44 | 32.4 | 42.2 | 22.3 | 30.2 | 32.4 | 42.2 | 17.8 | 29.5 | 19 | 27.4 | 18.1 | 29 |
| passes | | | | | | | | | | | | |
| scrubbing | | | | | | | | | | | | |

Thus, various embodiments of methods and compositions for restoring and maintaining a polished concrete floor are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

As used herein, the term “configured to” may be used interchangeably with the terms “adapted to” or “structured to” unless the content of this disclosure clearly dictates otherwise.

The term “or” is generally employed in its inclusive sense, for example, to mean “and/or” unless the context clearly dictates otherwise. The term “and/or” means one or all of the listed elements or a combination of at least two of the listed elements.

The phrases “at least one of” and “one or more of” followed by a list refers to any one of the items in the list and any combination of two or more items in the list.

1. A surface enhancement solution comprising:
water;
a first nonionic surfactant comprising alcohol alkoxylate;
a second nonionic surfactant comprising alcohol alkoxylate different than the first nonionic surfactant; and
a third nonionic surfactant comprising an amide functional group.

2. The solution of claim 1, further comprising a solubilizing agent for the third nonionic surfactant.

3. The solution of claim 2, wherein an amount of the third nonionic surfactant relative to an amount of the solubilizing agent ranges between 1:2 to 2:1 ratio by weight.

4. The solution of claim 1, wherein the solution is a ready to use solution, wherein the water comprises at least 98 parts by weight of 100 parts by weight of the total solution.

5. The solution of claim 1, further comprising a glycol ether solvent.

6. The solution of claim 1, further comprising a polymer.

7. The solution of claim 1, further comprising a silicate.

8. The solution of claim 1, further comprising nanosilica particles.

9. The solution of claim 1, wherein an amount of the first nonionic surfactant relative to an amount of the second nonionic surfactant ranges between 1:9 to 9:1 ratio by weight.

10. A surface enhancement solution comprising:
water;
a nonionic surfactant comprising alcohol alkoxylate;
a polymer; and
a siloxane.

11. The solution of claim 10, further comprising a glycol ether solvent.

12. The solution of claim 10, further comprising a silicate.

13. The solution of claim 10, further comprising siliconate.

14. A method for restoring and maintaining a hard surface comprising:
applying a first fluid to the hard surface;
providing one, two, or three structured-abrasive pads each having a unique level of abrasive action;
grinding the hard surface using the one, two, or three structured-abrasive pads and concurrently removing the first fluid from the hard surface to restore the hard surface;
applying a second fluid to the hard surface; and
scrubbing the hard surface using a floor bristle brush and concurrently removing the second fluid from the hard surface to maintain the hard surface, wherein the floor bristle brush has bristles comprising moldable polymeric material and abrasive particle additives.

15. The method of claim 14, wherein the first or second fluid comprises either water only or a surface enhancement solution according to any one of claims 1 to 13.

16. The method of claim 14, wherein one or both of the first fluid and the second fluid are free of abrasive particles harder than the hard surface.

17. The method of claim 14, wherein the first fluid and the second fluid are the same type of fluid.

18. The method of claim 14, wherein applying the first fluid is continuous and concurrent with grinding the hard surface.

19. The method of claim 14, wherein applying the second fluid is continuous and concurrent with scrubbing the hard surface.

20. The method of claim 14, wherein the hard surface is a concrete floor having an average 60 degree gloss of at least 10 and an average distinctness of image of at least 20 after scrubbing for 6 passes.
